(19) United States
(12) Patent Application Publication
(10) Pub. No.: US 2022/0325020 A1
(43) Pub. Date: Oct. 13, 2022

(54) CROSS-LINKED METHACRYLATE RESIN PARTICLES AND A PORE-FORMING AGENT

(71) Applicant: ENEOS Corporation, Tokyo (JP)

(72) Inventor: Hiroaki MURAKAMI, Tokyo (JP)

(73) Assignee: ENEOS Corporation, Tokyo (JP)

(21) Appl. No.: 17/634,528

(22) PCT Filed: Jul. 8, 2020
(86) PCT No.: PCT/JP2020/026709

§ 371 Date: Feb. 10, 2022

(30) Foreign Application Priority Data
Aug. 29, 2019 (JP) 2019-157189

(51) Int. Cl. C08F 220/14

(52) U.S. Cl. CPC C08F 220/14

(57) ABSTRACT

Disclosed are resin particles having excellent thermal decomposability and suitable hardness. The resin particles are cross-linked methacrylate resin particles obtained by polymerizing monofunctional methacrylate and polyfunctional methacrylate, wherein the blending amount of the monofunctional methacrylate is 60% by mass to 95% by mass and the blending amount of the polyfunctional methacrylate is 5% by mass to 40% by mass with respect to the total amount of methacrylate compound, being a raw material for the polymerization reaction; the number of carbon atoms in the ester substituent of the monofunctional methacrylate is 3 or less; and 5% mass reduction temperature of the cross-linked methacrylate resin particles as measured by thermogravimetric differential thermal analysis is 180° C. or more and 240° C. or less.

### BACKGROUND OF THE INVENTION

### Field of the Invention

The present invention relates to cross-linked methacrylate resin particles. Further, the present invention relates to a pore-forming agent containing the cross-linked methacrylate resin particles.

### Background Art

Conventionally, resin particles have been used for various purposes, for example, in additives for coating materials (matting agents, design-imparting agents for imparting fine concavity and convexity to the surface of coating films, etc.), additives for inks (matting agents, etc.), main components or additives for adhesives, additives for artificial marble (shrinkage reducing agents, etc.), paper processing agents, fillers for cosmetics (fillers for improving slipperiness), column fillers for chromatography, additives for toners used in electrostatic charge image development, blocking inhibitors for films, light diffusion agents for light diffusion materials (light diffusion films, etc.), electrode materials for solid oxide fuel cells, insulating layers for insulating wires, etc.

In the process for producing an electrode material for a solid oxide fuel cell, a pore-forming agent, a ceramic raw material powder, a binder, a dispersing agent, an organic solvent and the like are mixed to prepare a slurry which is then applied to a support and molded into a sheet, thereby fabricating a ceramic green sheet. Such ceramic green sheets are laminated and burned, thereby producing an electrode material. However, in the conventional method, organic components remained on the electrode surface after burning, and such organic residues caused the efficiency of the battery to decrease. Also there was a problem that the surface area of the fuel electrode to be obtained reduced when the pore-forming agent had poor decomposition property at a low temperature. To solve such problems, Patent Document 1 proposes the use of acrylic resin particles obtained by polymerizing a monomer composition containing isobutyl methacrylate, alkyl methacrylate having an ester substituent of an alkyl group having 4 or less carbon atoms, polyfunctional (meth)acrylate and two or more emulsifiers, the acrylic resin particles having a mass reduction rate of not less than a specific value when the ratio of each component and the particle diameter are adjusted and heating was conducted at 300° C. and 350° C. for one hour. In Patent Documents 2 and 3, it is also proposed to use (meth)acrylic resin particles having a specific average particle diameter and a coefficient of variation of particle size within specific ranges, as a pore-forming agent for an electrode material of a solid oxide fuel cell.

### PRIOR ART DOCUMENTS

### Patent Documents

Patent Document 1: Japanese Patent Laid-Open Publication No. 2018-125277

Patent Document 2: Japanese Patent Laid-Open Publication No. 2007-220731

Patent Document 3: Japanese Patent Laid-Open Publication No. 2011-34819

### SUMMARY OF THE INVENTION

### Problems to be Solved by the Invention

However, there is room for improvement in thermal decomposability since the resin fine particles described in Patent Document 1 use 70 to 95% by weight of isobutyl methacrylate as an essential raw material, there is a concern that cracks may occur in the substrate due to rapid decomposition when thermal decomposition starts. Further, since the resin fine particles described in Patent Document 1 have too high flexibility and are easily deformed due to the low glass transition temperature of the resin, there is a risk that controlling of the pores in the substrate becomes insufficient when they were used as a pore-forming agent. Therefore, there is a need for resin particles having excellent thermal decomposability and suitable hardness.

Conventionally, it has been considered that thermal decomposition proceeds easily with the raw material of (meth)acrylate having a longer molecular chain. Therefore, it has been proposed to use a compound having four or more carbon atoms in an ester substituent such as butyl(meth)acrylate or octyl(meth)acrylate as described in Patent Document 1. However, the present inventor has unexpectedly found that using methacrylate instead of acrylate and making the molecular chain of methacrylate relatively short can also make thermal decomposition to easily proceed and reduce the residue after decomposition.

Accordingly, it is an object of the present invention to provide resin particles having excellent thermal decomposability and suitable hardness. It is another object of the present invention to provide a pore-forming agent containing the resin particles.

### Means for Solving the Problem

As a result of intensive studies to solve the above-mentioned problems, the present inventors have found that the above-mentioned problems can be solved with cross-linked methacrylate resin particles obtained by polymerizing monofunctional methacrylate and polyfunctional methacrylate, wherein the blending ratio of the monofunctional methacrylate and the polyfunctional methacrylate is adjusted and the number of carbon atoms of the ester substituent of the monofunctional methacrylate is determined as 3 or less. The present invention has been completed based on such knowledge.

That is, according to one embodiment of the present invention, there is provided cross-linked methacrylate resin particles obtained by polymerizing monofunctional methacrylate and polyfunctional methacrylate, wherein

the blending amount of the monofunctional methacrylate is 60% by mass or more and 95% by mass or less and the blending amount of the polyfunctional methacrylate is 5% by mass or more and 40% by mass or less with respect to the total amount of methacrylate compound which is a raw material for the polymerization reaction;

the number of carbon atoms in the ester substituent of the monofunctional methacrylate is 3 or less; and

5% mass reduction temperature of the cross-linked methacrylate resin particles as measured by thermogravimetric differential thermal analysis is 180° C. or more and 240° C. or less.

In an embodiment of the present invention, the monofunctional methacrylate is preferably at least one selected from the group consisting of methyl methacrylate, ethyl methacrylate, n-propyl methacrylate, isopropyl methacrylate, hydroxyethyl methacrylate, hydroxypropyl methacrylate, and glycidyl methacrylate.

In an embodiment of the present invention, the polyfunctional methacrylate is preferably at least one selected from the group consisting of ethylene glycol dimethacrylate, diethylene glycol dimethacrylate, triethylene glycol dimethacrylate, tripropylene glycol dimethacrylate, polypropylene glycol dimethacrylate, polyethylene glycol dimethacrylate, and glycerin dimethacrylate.

In an embodiment of the present invention, the compressive elastic modulus at 10% compression deformation is preferably 2000 N/mm² or more and 3000 N/mm² or less.

In an embodiment of the present invention, when the temperature is increased from 40° C. to 450° C. as measured by thermogravimetric differential thermal analysis, the amount of residue at the end of temperature increase is preferably 2.0% by mass or less.

In an embodiment of the present invention, the decomposition rate from 5% mass reduction temperature to 50% mass reduction temperature is preferably 2.0% by mass/° C. or less as measured by thermogravimetric differential thermal analysis.

In the embodiment of the present invention, the average particle diameter of the cross-linked methacrylate resin particles is preferably 0.5 μm or more and 20 μm or less.

In the embodiment of the present invention, the coefficient of variation of the particle size of the cross-linked methacrylate resin particles is preferably 10% or more and 50% or less.

In another embodiment of the present invention, there is provided a pore-forming agent comprising the cross-linked methacrylate resin particles.

In another embodiment of the present invention, the pore-forming agent described above is preferably used for forming a solid oxide fuel cell.

In another embodiment of the present invention, the above-described pore-forming agent is preferably used for forming an insulating wire.

### Effect of the Invention

According to the present invention, it is possible to provide cross-linked methacrylic resin particles having excellent thermal decomposability and suitable hardness. Such cross-linked methacrylic resin particles can be suitably used as a pore-forming agent.

### BRIEF DESCRIPTION OF THE DRAWINGS

FIG. 1 shows decomposition curves measured by thermogravimetric differential thermal analysis of resin particles of Example 1, Comparative Example 2, and Comparative Example 13.

### CROSS-LINKED METHACRYLIC RESIN PARTICLES

The resin particles according to the present invention are methacrylate resin particles obtained by polymerizing specific monofunctional methacrylate and polyfunctional methacrylate described in details below, and have a structure in which each polymer chain is cross-linked by the polyfunctional methacrylate. By blending and polymerizing these two types of monomers at a specific ratio, it is possible to suppress rapid decomposition due to temperature increase while lowering the temperature until the start of decomposition due to heat of the cross-linked methacrylate resin particles. Therefore, when used as a pore-forming agent for a substrate, pores in the substrate are gradually formed, so that the pore forming process can be easily controlled. In addition, the hardness of the cross-linked methacrylate resin particles can be adjusted to an appropriate range, and as a result, the resin particles are less likely to deform in the substrate, and the pore forming process can be easily controlled.

### (Monofunctional Methacrylate)

The monofunctional methacrylate is not particularly limited as long as the number of carbon atoms in the ester substituent is 3 or less. Examples of the monofunctional methacrylate include methyl methacrylate, ethyl methacrylate, n-propyl methacrylate, isopropyl methacrylate, hydroxyethyl methacrylate, hydroxypropyl methacrylate, glycidyl methacrylate and the like. One of these monofunctional methacrylates may be used alone or two or more in combination. In particular, it is preferable to use methyl methacrylate and glycidyl methacrylate in combination. In the present invention, by using monofunctional methacrylate instead of monofunctional acrylate and setting the number of carbon atoms of the ester substituent of the monofunctional methacrylate to 3 or less, it is possible to adjust into a suitable hardness while improving thermal decomposability.

The blending amount of the monofunctional methacrylate is 60% by mass or more and 95% by mass or less, the lower limit is preferably 65% by mass or more, more preferably 70% by mass or more, and the upper limit is preferably 90% by mass or less, and more preferably 85% by mass or less, with respect to the total amount of methacrylate compound which is the raw material for the polymerization reaction. When glycidyl methacrylate is used, the blending amount of glycidyl methacrylate is preferably 5% by mass or more and 30% by mass or less, more preferably 10% by mass or more and 20% by mass or less with respect to the total amount of methacrylate compound of the raw material. When the blending amount of monofunctional methacrylate is within the above-mentioned numerical ranges, it is possible to adjust into a suitable hardness while improving thermal decomposability.

### (Polyfunctional Methacrylate)

Polyfunctional methacrylate means methacrylate having two or more functional groups, and it is preferable to use a methacrylate having two or more functional groups and six or less functional groups, and more preferable to use a methacrylate having two or more functional groups and four or less functional groups. One of the polyfunctional methacrylate may be used alone or two or more in combination. Further, polyfunctional methacrylates having different numbers of functional groups may be used in combination.

Examples of bifunctional methacrylate include ethylene glycol dimethacrylate, diethylene glycol dimethacrylate, triethylene glycol dimethacrylate, tripropylene glycol dimethacrylate, polypropylene glycol dimethacrylate, polyethylene glycol dimethacrylate, glycerin dimethacrylate, 1,3-butanediol dimethacrylate, 1,4-butanediol dimethacrylate, ethoxylated bisphenol A dimethacrylate, ethoxylated bisphenol F dimethacrylate, 1,6-hexanediol dimethacrylate, 1,9-nonanediol dimethacrylate, 1,10-decanediol dimethacrylate, neopentyl glycol dimethacrylate, propoxylated neopentyl glycol dimethacrylate, pentaerythritol diacrylate monostearate, isocyanuric acid ethoxy-modified dimethacrylate (isocyanuric acid EO-modified dimethacrylate), and the like. Among these, it is preferable to use ethylene glycol dimethacrylate, diethylene glycol dimethacrylate, triethylene glycol dimethacrylate, tripropylene glycol dimethacrylate, polypropylene glycol dimethacrylate, polyethylene glycol dimethacrylate, glycerin dimethacrylate and the like.

Examples of trifunctional methacrylate include pentaerythritol trimethacrylate, trimethylolpropane trimethacrylate, trimethylolpropane EO-modified trimethacrylate, isocyanuric acid EO-modified trimethacrylate, ethoxylated trimethylolpropane trimethacrylate, propoxylated trimethylolpropane trimethacrylate, propoxylated glyceryl trimethacrylate, trifunctional polyester methacrylate, and the like.

Examples of tetrafunctional methacrylate include pentaerythritol tetramethacrylate, ditrimethylol propane tetramethacrylate, ethoxylated pentaerythritol tetramethacrylate and the like.

The blending amount of the polyfunctional methacrylate is 5% by mass or more and 40% by mass or less, the lower limit is preferably 10% by mass or more, more preferably 15% by mass or more, and the upper limit is preferably 35% by mass or less, more preferably 30% by mass or less with respect to the total amount of methacrylate compound which is the raw material for the polymerization reaction. When the blending amount of the polyfunctional methacrylate is within the above-mentioned numerical ranges, it is possible to adjust into a suitable hardness while improving thermal decomposability.

As a raw material for the cross-linked methacrylic resin particles of the present invention, it is preferable that the blending amounts of the above-mentioned methacrylate and acrylates other than the monofunctional methacrylate and the polyfunctional methacrylate are as small as possible so as not to impair the effect of the present invention. For example, the blending amount of the acrylate is preferably less than 1% by mass, more preferably less than 0.5% by mass, further preferably less than 0.1% by mass, and further more preferably 0% by mass with respect to the total amount of the monomer which is the raw material for the polymerization reaction.

A polymerization initiator may be usually used for the polymerization reaction of the monofunctional methacrylate and the polyfunctional methacrylate. Examples of the polymerization initiator include an oil-soluble peroxide-based polymerization initiator used in water-based suspension polymerization and an azo-based polymerization initiator. Specifically, examples of the polymerization initiator include peroxide-based polymerization initiators such as benzoyl peroxide, lauroyl peroxide, octanoyl peroxide, ortho-chlorobenzoyl peroxide, ortho-methoxybenzoyl peroxide, methyl ethyl ketone peroxide, diisopropyl peroxydicarbonate, cumene hydroperoxide, cyclohexanone peroxide, t-butyl hydroperoxide, diisopropylbenzene hydroperoxide; azo-based initiators such as

azobisvaleronitrile, 2,2′-azobisisobutyronitrile, 2,2′-azobis(2,4-dimethylvaleronitrile), 2,2′-azobis(2,3-dimethylbutyronitrile), 2,2′-azobis(2-methylbutyronitrile), 2,2′-azobis(2,3,3-trimethylbutyronitrile), 2,2′-azobis(2-isopropylbutyronitrile), 1,1′-azobis(cyclohexane-1-carbonitrile), 2,2′-azobis(4-methoxy-2,4-dimethylvaleronitrile), and (2-carbamoylazo)isobutyronitrile, 4,4′-azobis(4-cyanovaleric acid), dimethyl-2,2′-azobisisobutyrate and the like. Among these, 2,2′-azobisisobutyronitrile, 2,2′-azobis(2,4-dimethylvaleronitrile), benzoyl peroxide, lauroyl peroxide and the like are preferable in view of having a decomposition rate of a polymerization initiator at a moderate rate. The adding amount of the polymerization initiator is preferably 0.01 to 10 parts by mass and more preferably 0.01 to 5 parts by mass with respect to 100 parts by mass of the methacrylate compound which is the raw material from the viewpoint of function and cost.

The above-mentioned monofunctional methacrylate and polyfunctional methacrylate can be prepared into a desired droplet diameter by dissolving a polymerization initiator in accordance with a conventional method and then stirring and mixing with an aqueous solution containing a polymerization stabilizer and a surfactant. The mixed solution is heated under stirring to carry out a polymerization reaction, thereby producing cross-linked methacrylic resin particles.

As a polymerization stabilizer, a water-soluble polymer such as polyvinyl alcohol and an inorganic stabilizer such as calcium phosphate can be used.

As a surfactant, use is made to a nonionic surfactant which does not affect the polymerization reactivity, and also ester types such as glycerin fatty acid ester and sorbitan fatty acid ester, ether types such as polyoxyethylene (or POE) alkyl ether, polyoxyethylene (or POE) alkyl phenyl ether, and polyoxyethylene polyoxypropylene glycol, ester ether types in which ethylene oxide is added to fatty acid or polyhydric alcohol fatty acid ester and in which both an ester bond and an ether bond exist in the molecule.

Cross-linked methacrylic resin particles obtained by polymerization are subjected to a solid-liquid separation step and a drying step and then taken out from the polymerization reaction liquid by crushing by an ordinary operation as a powder to be used. That is, after obtaining a wet cake by centrifugal separation and then removing moisture by a shelf drying method, a spray drying method, or the like, the aggregation is loosened by being applied impact by a hammer mill, a bead mill, or the like to obtain primary or secondary particles.

### (Resin Particle Physical Properties)

When the temperature of the cross-linked methacrylic resin particles is increased from 40° C. to 450° C. at a rate of 10° C./min as measured by thermogravimetric differential thermal analysis (TG/DTA), the temperature at which the mass decreases by 5% (5% mass reduction temperature) with respect to 100% of the mass of the resin particles at 100° C. is 180° C. or more and 240° C. or less, the lower limit is preferably 185° C. or more, more preferably 190° C. or more, and the upper limit is preferably 230° C. or less, more preferably 225° C. or less, and further preferably 220° C. or less. When the 5% mass reduction temperature is within the above numerical value range, the resin particles rapidly disappear in the substrate during heating, and the pore forming process can be easily controlled. When the 5% mass reduction temperature is less than 180° C., there is a risk that troubles such as adhesion, decomposition or deterioration of the particles may occur in the production step of the resin particles, particularly in the drying step.

When the temperature is increased from 40° C. to 450° C. as measured by the TG/DTA, the amount of residue of the cross-linked methacrylic resin particles according to the present invention at the end of the increase in temperature (when the temperature reaches 450° C.) is preferably 2.0% by mass or less, more preferably 1.5% by mass or less, and further preferably 1.3% by mass or less. When the amount of residue is within the above-mentioned numerical value ranges, it is possible to prevent adverse effects on the performance of the product using the substrate since almost no residue of the resin particles remains in the pores of the substrate by heating.

In the measurement by TG/DTA, the cross-linked methacrylic resin particles according to the present invention exhibit a decomposition rate from 5% mass reduction temperature to 50% mass reduction temperature of preferably 2.0% by mass/° C. or less, a lower limit of preferably 0.2% by mass/° C. or more, more preferably 0.3% by mass/° C. or more, further preferably 0.5% by mass/° C. or more, an upper limit of more preferably 1.8% by mass/° C. or less, further preferably 1.7% by mass/° C. or less, and further more preferably 1.6% by mass/° C. or less. When the decomposition rate is within the above-mentioned numerical value ranges, the resin particles are gradually decomposed, so that the pores in the substrate are gradually formed, whereby the pore forming process can be controlled easily. Since a rapid volume change does not easily occur in the substrate, it is possible to prevent cracks from occurring in the substrate.

The average particle diameter of the cross-linked methacrylic resin particles according to the present invention is not particularly limited, and is preferably 0.5 μm or more and 20 μm or less, the lower limit is more preferably 0.7 μm or more, further preferably 1.0 μm or more, further more preferably 1.5 μm or more, and the upper limit is more preferably 15 μm or less, further preferably 12 μm or less, and further more preferably 10 μm or less. When the average particle diameter of the resin particles is within the above-mentioned numerical value ranges, uniform pores are easily formed in the substrate.

The average particle diameter of the resin particles can be measured by using a precise particle diameter distribution measuring device (Multisizer 4 manufactured by Beckman Coulter Co., Ltd., predetermined aperture diameter: 30 μm aperture used when the average particle diameter is less than 5 μm, and 70 μm aperture used when the average particle diameter is 5 μm or more). The shape of the resin particles is not particularly limited, and a spherical shape, a spheroid, or the like is preferable.

The cross-linked methacrylic resin particles according to the present invention have a suitable hardness when the compressive elastic modulus at 10% compression deformation is within a specific numerical range. The compressive elastic modulus at 10% compression deformation (hereinafter referred to as “10% K value”) in the present invention is a compressive elastic modulus at a displacement of 10% of the particle diameter. The 10% K value is a value calculated from the following formula (I) by applying load using a micro compression tester (MCT-210 manufactured by Shimadzu Corporation), at a constant speed in the vertical downward direction by a diamond circular indenter having a diameter of 20 μm at room temperature (25° C.) to one resin particle dispersed on a sample stage and measuring the load value and the compressive displacement at 10% compression deformation of the resin particle diameter. The 10% K value represents the flexibility of the resin particles in a universal and quantitative manner, and by using the 10% K value, the suitable hardness of the resin particles can be expressed quantitatively and unambiguously.

K=(3/√2)·F·10⁻³·S^{(-3/2)}·R^{(-1/2)} Formula (I)

In the formula,

K: compressive elastic modulus at 10% compressive deformation of the resin particle (N/mm²)

F: load value at 10% compressive deformation of the resin particle (N)

S: compressive displacement at 10% compressive deformation of the resin particle (mm)

R: radius of the resin particle (mm)

The cross-linked methacrylic resin particles according to the present invention have a 10% K value of preferably 2000 N/mm² or more and 3000 N/mm² or less, a lower limit value of more preferably 2050 N/mm² or more, further preferably 2100 N/mm² or more, and an upper limit value of more preferably 2900 N/mm² or less, further preferably 2800 N/mm² or less, and further more preferably 2500 N/mm² or less. When the 10% K value is within the above-mentioned numerical value ranges, it is easy to control the pore forming process because the hardness is suitable.

The coefficient of variation (Cv) of the particle size of cross-linked methacrylic resin particles according to the present invention is preferably 10% or more and 50% or less in order to facilitate the control of the pore forming process. The lower limit of Cv is more preferably 15% or more, further preferably 18% or more, further more preferably 20% or more, and the upper limit is more preferably 48% or less, more preferably 47% or less, and further more preferably 45% or less. The smaller the value of Cv (closer to 0), the narrower the particle diameter distribution, the more even the particle diameter, and the more uniform the particle size. A method for measuring Cv according to the present invention is as described in the Examples. If Cv is within the above ranges, even pores are easily formed in the substrate.

<Pore Forming Agent>

The pore forming agent according to the present invention comprises the above-described cross-linked methacrylic resin particles. By heating the substrate containing the pore forming agent, the pore forming agent is thermally decomposed (vaporized), and pores can be formed in the place where the pore forming agent existed.

The pore-forming agent according to the present invention can be applied to various conventionally known applications. For example, it can be used for forming an electrode material of a solid oxide fuel cell, a ceramic filter, an insulating layer of an insulating wire, and the like.

The substrate containing the pore-forming agent is not particularly limited, and can be appropriately selected according to various applications. Examples of the substrate include ceramics, resin substrates, and the like.

### EXAMPLES

Hereinafter, the present invention shall be more specifically described with reference to the following Examples, but the present invention shall not be limited to the following Examples.

First, the following raw materials were prepared for the production of resin particles of the Examples and Comparative Examples.

<Monofunctional Methacrylate>
MMA: methyl methacrylate (manufactured by Mitsubishi Rayon Co., Ltd.)
GMA: glycidyl methacrylate (manufactured by Fujifilm Wako Pure Chemical Corporation)
n-BMA: n-butyl methacrylate (manufactured by Fujifilm Wako Pure Chemical Corporation)
i-BMA: i-butyl methacrylate (manufactured by Fujifilm Wako Pure Chemical Corporation)
OMA: 2-ethylhexyl methacrylate (manufactured by Fujifilm Wako Pure Chemical Corporation)
DMA: n-dodecyl methacrylate (manufactured by Fujifilm Wako Pure Chemical Corporation)

### <Monofunctional Acrylate>

MA: methyl acrylate (manufactured by Fujifilm Wako Pure Chemical Corporation)
EA: ethyl acrylate (manufactured by Fujifilm Wako Pure Chemical Corporation)
BA: n-butyl acrylate (manufactured by Fujifilm Wako Pure Chemical Corporation)
OA: 2-ethylhexyl acrylate (manufactured by Fujifilm Wako Pure Chemical Corporation)

### <Polyfunctional Methacrylate>

1G: bifunctional methacrylate represented by the following formula (product name: 1G (ethylene glycol dimethacrylate), manufactured by Shin-Nakamura Chemical Co., Ltd.)

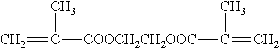

14G: bifunctional methacrylate represented by the following formula (product name: 14G (polyethylene glycol #600 dimethacrylate), manufactured by Shin-Nakamura Chemical Co., Ltd.)

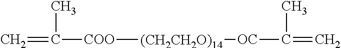

9PG: bifunctional methacrylate represented by the following formula (product name: 9PG (polypropylene glycol #400 dimethacrylate), manufactured by Shin-Nakamura Chemical Co., Ltd.)

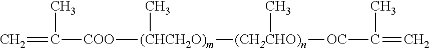

(wherein m+n=7)

### <Polyfunctional Acrylate>

TMPTA: trimethylolpropane triacrylate (product name: TMPTA, manufactured by Shin-Nakamura Chemical Co., Ltd.)
A-600: bifunctional acrylate represented by the following formula (product name: A-600 (polyethylene glycol #600 diacrylate), manufactured by Shin-Nakamura Chemical Co., Ltd.)

CH₂═CHCOO—(CH₂—CH₂)₁₄—OCCH═CH₂
APG-400: bifunctional acrylate represented by the following formula (product name: APG-400 (polypropylene glycol (#400) diacrylate), manufactured by Shin-Nakamura Chemical Co., Ltd.)

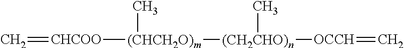

(wherein m+n=7)

### <Production of Resin Particles>

### Example 1

To the dispersion vessel were added 200 parts by mass of deionized water and 2 parts by mass of polyvinyl alcohol (product name: PVA217-EE, manufactured by Kuraray Co., Ltd.) as a dispersant. Further 80 parts by mass of methyl methacrylate as monofunctional methacrylate, 10 parts by mass of 1G and 10 parts by mass of 14G as polyfunctional methacrylate, and 0.5 parts by mass of lauryl peroxide as a polymerization initiator were added to the aqueous solution in the dispersion vessel to prepare a mixed liquid. The obtained mixed liquid was subjected to dispersion treatment by a disperser for a predetermined time to obtain a dispersion liquid in which the droplet diameter was adjusted. The dispersion liquid was injected into a polymerization reactor equipped with a stirrer, a thermometer, a reflux condenser and a nitrogen inlet, and the polymerization reaction was carried out at 80° C. under nitrogen inflow for 4 hours. The polymerization reaction liquid was subjected to solid-liquid separation by centrifugal sedimentation to obtain a cross-linked methacrylic resin. The obtained cross-linked methacrylic resin was re-dispersed in ion-exchanged water and centrifuged to wash the surfactant. Subsequently, drying was carried out at 80° C. under reduced pressure for 12 hours and then crushing was performed to obtain cross-linked methacrylic resin particles.

### Example 2

Cross-linked methacrylic resin particles were obtained in the same manner as in Example 1, except that 80 parts by mass of methyl methacrylate was used as the monofunctional methacrylate and 20 parts by mass of 9PG was used as the polyfunctional methacrylate.

### Example 3

Cross-linked methacrylic resin particles were obtained in the same manner as in Example 1, except that 60 parts by mass of methyl methacrylate was used as the monofunctional methacrylate and 40 parts by mass of 9PG was used as the polyfunctional methacrylate.

### Example 4

Cross-linked methacrylic resin particles were obtained in the same manner as in Example 1, except that 1 part of polyoxyethylene alkyl ether sulfate (product name: HITENOL NF-17, manufactured by DKS Co., Ltd.) was used as the dispersant, 95 parts by mass of methyl methacrylate was used as the monofunctional methacrylate, and 5 parts by mass of 9PG was used as the polyfunctional methacrylate.

### Example 5

Cross-linked methacrylic resin particles were obtained in the same manner as in Example 1, except that 75 parts by mass of methyl methacrylate and 5 parts by mass of glycidyl methacrylate were used as the monofunctional methacrylate, and 20 parts by mass of 9PG was used as the polyfunctional methacrylate.

### Example 6

Cross-linked methacrylic resin particles were obtained in the same manner as in Example 1, except that 60 parts by mass of methyl methacrylate and 20 parts by mass of glycidyl methacrylate were used as the monofunctional methacrylate, and 20 parts by mass of 9PG was used as the polyfunctional methacrylate.

### Example 7

Cross-linked methacrylic resin particles were obtained in the same manner as in Example 1, except that 1 part of polyoxyethylene alkyl ether sulfate (product name: HITENOL NF-17, manufactured by DKS Co., Ltd.) was used as a dispersant, 70 parts by mass of methyl methacrylate and 10 parts by mass of glycidyl methacrylate were was used as the monofunctional methacrylate, and 20 parts by mass of 9PG was used as the polyfunctional methacrylate.

### Example 8

Cross-linked methacrylic resin particles were obtained in the same manner as in Example 1, except that 1 part of polyoxyethylene alkyl ether sulfate (product name: HITENOL NF-17, manufactured by DKS Co., Ltd.) was used as a dispersant, 70 parts by mass of methyl methacrylate and 10 parts by mass of glycidyl methacrylate were used as the monofunctional methacrylate, and 5 parts by mass of 1G and 20 parts by mass of 9PG were used as the polyfunctional methacrylate.

### Comparative Example 1

Cross-linked methacrylic resin particles were obtained in the same manner as in Example 1, except that 1 part of polyoxyethylene alkyl ether sulfate (product name: HITENOL NF-17, manufactured by DKS Co., Ltd.) was used as a dispersant, 55 parts by mass of methyl methacrylate and 25 parts by mass of n-butyl methacrylate were used as the monofunctional methacrylate, and 20 parts by mass of 9PG was used as the polyfunctional methacrylate.

### Comparative Example 2

Cross-linked (meth)acrylic resin particles were obtained in the same manner as in Example 1, except that 80 parts by mass of methyl methacrylate was used as the monofunctional methacrylate and 20 parts by mass of trimethylolpropane triacrylate was used as the polyfunctional acrylate.

### Comparative Example 3

Cross-linked methacrylic resin particles were obtained in the same manner as in Example 1, except that 80 parts by mass of methyl methacrylate was used as the monofunctional methacrylate and 20 parts by mass of 1G was used as the polyfunctional methacrylate.

### Comparative Example 4

Cross-linked (meth)acrylic resin particles were obtained in the same manner as in Example 1, except that 70 parts by mass of methyl methacrylate was used as the monofunctional methacrylate, 10 parts by mass of methyl acrylate was used as the monofunctional acrylate, and 20 parts by mass of 1G was used as the polyfunctional methacrylate.

### Comparative Example 5

Cross-linked acrylic resin particles were obtained in the same manner as in Example 1, except that 80 parts by mass of ethyl acrylate was used as the monofunctional acrylate and 20 parts by mass of trimethylolpropane triacrylate was used as the polyfunctional acrylate.

### Comparative Example 6

Cross-linked acrylic resin particles were obtained in the same manner as in Example 1, except that 1 part of polyoxyethylene alkyl ether sulfate (product name: HITENOL NF-17, manufactured by DKS Co., Ltd.) was used as a dispersant, 80 parts by mass of n-butyl acrylate was used as the monofunctional acrylate, and 20 parts by mass of trimethylolpropane triacrylate was used as a polyfunctional acrylate.

### Comparative Example 7

Cross-linked (meth)acrylic resin particles were obtained in the same manner as in Example 1, except that 80 parts by mass of 2-ethylhexyl acrylate was used as the monofunctional acrylate and 20 parts by mass of 1G was used as the polyfunctional methacrylate.

### Comparative Example 8

Cross-linked methacrylic resin particles were obtained in the same manner as in Example 1, except that 90 parts by mass of n-butyl methacrylate was used as the monofunctional methacrylate and 10 parts by mass of 1G was used as the polyfunctional methacrylate.

### Comparative Example 9

Cross-linked methacrylic resin particles were obtained in the same manner as in Example 1, except that 1 part of polyoxyethylene alkyl ether sulfate (product name: HITENOL NF-17, manufactured by DKS Co., Ltd.) was used as the dispersant, 90 parts by mass of isobutyl methacrylate was used as the monofunctional methacrylate, and 10 parts by mass of 1G was used as the polyfunctional methacrylate.

### Comparative Example 10

Cross-linked methacrylic resin particles were obtained in the same manner as in Example 1, except that 95 parts by mass of n-butyl methacrylate was used as the monofunctional methacrylate and 5 parts by mass of 1G was used as the polyfunctional methacrylate.

### Comparative Example 11

Cross-linked methacrylic resin particles were obtained in the same manner as in Example 1, except that 50 parts by mass of methyl methacrylate and 30 parts by mass of 2-ethylhexyl methacrylate were used as the monofunctional methacrylate and 20 parts by mass of 1G was used as the polyfunctional methacrylate.

### Comparative Example 12

Cross-linked methacrylic resin particles were obtained in the same manner as in Example 1, except that 20 parts by mass of methyl methacrylate and 60 parts by mass of 2-ethylhexyl methacrylate were used as the monofunctional methacrylate and 20 parts by mass of 1G as the polyfunctional methacrylate.

### Comparative Example 13

Cross-linked methacrylic resin particles were obtained in the same manner as in Example 1, except that 60 parts by mass of methyl methacrylate, 30 parts by mass of n-dodecyl methacrylate were used as the monofunctional methacrylate and 10 parts by mass of 1G as the polyfunctional methacrylate.

### Comparative Example 14

Cross-linked methacrylic resin particles were obtained in the same manner as in Example 1, except that 1 part of polyoxyethylene alkyl ether sulfate (product name: HITENOL NF-17, manufactured by DKS Co., Ltd.) was used as the dispersant, 10 parts by mass of methyl methacrylate and 80 parts by mass of 2-ethylhexyl methacrylate were used as the monofunctional methacrylate, and 10 parts by mass of 1G was used as the polyfunctional methacrylate.

### Comparative Example 15

Cross-linked (meth)acrylic resin particles were obtained in the same manner as in Example 1, except that 80 parts by mass of n-butyl methacrylate was used as the monofunctional methacrylate and 20 parts by mass of A-600 was used as the polyfunctional acrylate.

### Comparative Example 16

Cross-linked (meth)acrylic resin particles were obtained in the same manner as in Example 1, except that 80 parts by mass of n-butyl methacrylate was used as the monofunctional methacrylate and 20 parts by mass of APG-400 was used as the polyfunctional acrylate.

Table 1 lists the composition of the resin particles obtained in the Examples and Comparative Examples.

TABLE 1

| | Monofunctional Methacrylate | | | | | | Monofunctional Acrylate | | | | Polyfunctional | | | | | |
|---|---|---|---|---|---|---|---|---|---|---|---|---|---|---|---|---|
| | MMA | GMA | n-BMA | i-BMA | OMA | DMA | MA | EA | BA | OA | Methacrylate | | | Polyfunctional Acrylate | | |
| | (C1) | (C3) | (C4) | (C4) | (C8) | (C12) | (C1) | (C2) | (C4) | (C8) | 1G | 14G | 9PG | TMPTA | A-600 | APG-400 |
| Ex. 1 | 80 | 0 | 0 | 0 | 0 | 0 | 0 | 0 | 0 | 0 | 10 | 10 | 0 | 0 | 0 | 0 |
| Ex. 2 | 80 | 0 | 0 | 0 | 0 | 0 | 0 | 0 | 0 | 0 | 0 | 0 | 20 | 0 | 0 | 0 |
| Ex. 3 | 60 | 0 | 0 | 0 | 0 | 0 | 0 | 0 | 0 | 0 | 0 | 0 | 40 | 0 | 0 | 0 |
| Ex. 4 | 95 | 0 | 0 | 0 | 0 | 0 | 0 | 0 | 0 | 0 | 0 | 0 | 5 | 0 | 0 | 0 |
| Ex. 5 | 75 | 5 | 0 | 0 | 0 | 0 | 0 | 0 | 0 | 0 | 0 | 0 | 20 | 0 | 0 | 0 |
| Ex. 6 | 60 | 20 | 0 | 0 | 0 | 0 | 0 | 0 | 0 | 0 | 0 | 0 | 20 | 0 | 0 | 0 |
| Ex. 7 | 70 | 10 | 0 | 0 | 0 | 0 | 0 | 0 | 0 | 0 | 0 | 0 | 20 | 0 | 0 | 0 |
| Ex. 8 | 75 | 10 | 0 | 0 | 0 | 0 | 0 | 0 | 0 | 0 | 5 | 0 | 10 | 0 | 0 | 0 |
| Co. Ex. 1 | 55 | 0 | 25 | 0 | 0 | 0 | 0 | 0 | 0 | 0 | 0 | 0 | 20 | 0 | 0 | 0 |
| Co. Ex. 2 | 80 | 0 | 0 | 0 | 0 | 0 | 0 | 0 | 0 | 0 | 0 | 0 | 0 | 20 | 0 | 0 |
| Co. Ex. 3 | 80 | 0 | 0 | 0 | 0 | 0 | 0 | 0 | 0 | 0 | 20 | 0 | 0 | 0 | 0 | 0 |
| Co. Ex. 4 | 70 | 0 | 0 | 0 | 0 | 0 | 10 | 0 | 0 | 0 | 20 | 0 | 0 | 0 | 0 | 0 |
| Co. Ex. 5 | 0 | 0 | 0 | 0 | 0 | 0 | 0 | 80 | 0 | 0 | 0 | 0 | 0 | 20 | 0 | 0 |
| Co. Ex. 6 | 0 | 0 | 0 | 0 | 0 | 0 | 0 | 0 | 80 | 0 | 0 | 0 | 0 | 20 | 0 | 0 |
| Co. Ex. 7 | 0 | 0 | 0 | 0 | 0 | 0 | 0 | 0 | 0 | 80 | 20 | 0 | 0 | 0 | 0 | 0 |
| Co. Ex. 8 | 0 | 0 | 90 | 0 | 0 | 0 | 0 | 0 | 0 | 0 | 10 | 0 | 0 | 0 | 0 | 0 |
| Co. Ex. 9 | 0 | 0 | 0 | 90 | 0 | 0 | 0 | 0 | 0 | 0 | 10 | 0 | 0 | 0 | 0 | 0 |
| Co. Ex. 10 | 0 | 0 | 95 | 0 | 0 | 0 | 0 | 0 | 0 | 0 | 5 | 0 | 0 | 0 | 0 | 0 |
| Co. Ex. 11 | 50 | 0 | 0 | 0 | 30 | 0 | 0 | 0 | 0 | 0 | 20 | 0 | 0 | 0 | 0 | 0 |
| Co. Ex. 12 | 20 | 0 | 0 | 0 | 60 | 0 | 0 | 0 | 0 | 0 | 20 | 0 | 0 | 0 | 0 | 0 |
| Co. Ex. 13 | 60 | 0 | 0 | 0 | 0 | 30 | 0 | 0 | 0 | 0 | 10 | 0 | 0 | 0 | 0 | 0 |
| Co. Ex. 14 | 10 | 0 | 0 | 0 | 80 | 0 | 0 | 0 | 0 | 0 | 10 | 0 | 0 | 0 | 0 | 0 |
| Co. Ex. 15 | 0 | 0 | 80 | 0 | 0 | 0 | 0 | 0 | 0 | 0 | 0 | 0 | 0 | 0 | 20 | 0 |
| Co. Ex. 16 | 0 | 0 | 80 | 0 | 0 | 0 | 0 | 0 | 0 | 0 | 0 | 0 | 0 | 0 | 0 | 20 |

### <Evaluation of Physical Properties of Resin Particles>

### (Measurement of Heat Resistance)

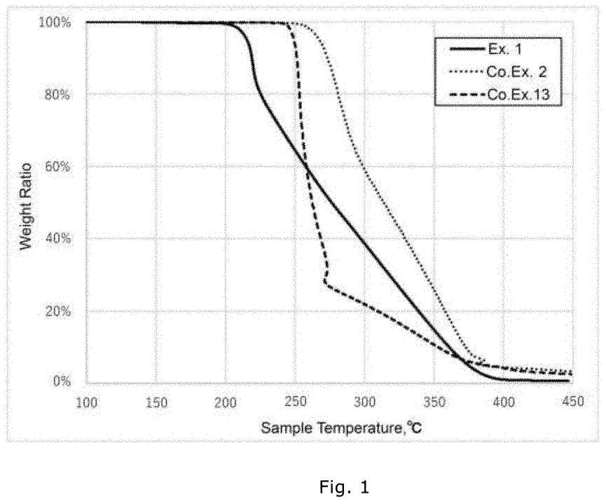

Thermal decomposability of each resin particle produced in the Examples and Comparative Examples was measured using TG/DTA7200, manufactured by SII Inc. Under an atmosphere having an air flow rate of 50 mL/min, the temperature was increased from 40° C. at a rate of 10° C./min to 450° C. Assuming that the mass of the sample at the time of reaching 100° C. was 100° C., the temperature at the time when the mass decreased by 5° C. was defined as a 50% mass reduction temperature, the temperature at the time when the mass decreases by 50% was defined as a 50% mass reduction temperature, and the mass ratio at the end of the temperature increase (at the time of reaching 450° C.) was defined as a residue amount (% by mass). Further, the decomposition rate (% by mass/° C. or less) from the 5% mass reduction temperature to the 50% mass reduction temperature was calculated. The measurement results are shown in Table 2. FIG. 1 shows the decomposition curves measured by thermogravimetric differential thermal analysis of the resin particles of Example 1, Comparative Example 2, and Comparative Example 13.

### (Measurement of Average Particle Size and Coefficient of Variation (Cv))

The average particle size and coefficient of variation (Cv) of each of the resin particles produced in the Examples and the Comparative Examples were measured using a precise particle diameter distribution measuring device (Multisizer 4 manufactured by Beckman Coulter Co., Ltd., aperture diameter 30 μm). The measurement results are shown in Table 2.

### (Measurement of 10% K Value)

Sample resin particles were sampled from each resin particle produced in the Examples and Comparative Examples. Then, using a micro-compression tester (MCT-210 manufactured by Shimadzu Corporation), load was applied to one sample resin particle (primary particle, particle diameter 5 μm) dispersed on a sample stage at a constant load speed in a vertical downward direction by a diamond circular indenter of 20 μm in diameter at room temperature (25° C.), and the load value and the compression displacement were measured when the sample resin particle was compressed to 10% of the particle diameter, and a 10% K value was calculated from the following formula. The calculation results are shown in Table 2. When the 10% K value is less than 2000 N/mm², the flexibility is too high, and when a strong force is applied to disperse the resin particles in the substrate, the resin particles are easily deformed, which has the risk that the control of the pore forming process becomes insufficient, and thus the resin particles are not suitable as a pore-forming agent.

K=(3/√2)·F·10⁻³·S^{(-3/2)}·R^{(-1/2)} Formula (I)

K: Compressive elastic modulus at 10% compressive deformation of resin particles (N/mm²)

F: Load value at 10% compressive deformation of resin particles (N)

S: Compression displacement at 10% compressive deformation of resin particles (mm)

R: Radius of resin particles (mm)

Table 2 shows measurement results of resin particles produced in the Examples and Comparative Examples.

TABLE 2

| | 5% mass | 450° C. | | | | |
|---|---|---|---|---|---|---|
| | reduction | Amount of | 5%→50% | Average | | |
| | temperature | residue | Decomposition rate | particle size | CV value | 10% K value |
| | (° C.) | (% by mass) | (% by mass/° C.) | (μm) | (%) | (N/mm²) |
| Ex. 1 | 215 | 0.7 | 0.7 | 3.5 | 43 | 2343 |
| Ex. 2 | 208 | 0.6 | 1.2 | 2.8 | 42 | 2324 |
| Ex. 3 | 197 | 1.3 | 0.9 | 8.3 | 42 | 2010 |
| Ex. 4 | 224 | 0.1 | 1.6 | 5.1 | 35 | 2440 |
| Ex. 5 | 204 | 0.7 | 0.9 | 2.1 | 39 | 2119 |
| Ex. 6 | 204 | 1.2 | 1.1 | 2.1 | 39 | 2238 |
| Ex. 7 | 204 | 1.0 | 1.6 | 3.3 | 30 | 2332 |
| Ex. 8 | 220 | 0.8 | 1.5 | 3.1 | 30 | 2291 |
| Co. Ex. 1 | 201 | 0.2 | 1.0 | 4.6 | 38 | 1810 |
| Co. Ex. 2 | 268 | 3.6 | 1.0 | 2.1 | 42 | 2600 |
| Co. Ex. 3 | 275 | 0.7 | 1.2 | 2.5 | 42 | 2800 |
| Co. Ex. 4 | 270 | 1.7 | 2.1 | 2.8 | 40 | 2851 |
| Co. Ex. 5 | 254 | 12.0 | 0.4 | 2.1 | 41 | 1650 |
| Co. Ex. 6 | 242 | 9.9 | 0.4 | 3.5 | 32 | 705 |
| Co. Ex. 7 | 238 | 8.6 | 0.4 | 7.5 | 43 | 841 |
| Co. Ex. 8 | 236 | 1.0 | 2.3 | 3.2 | 40 | 1096 |
| Co. Ex. 9 | 246 | 0.2 | 2.9 | 3.2 | 29 | 1852 |
| Co. Ex. 10 | 231 | 1.1 | 1.9 | 3.5 | 40 | 1152 |
| Co. Ex. 11 | 239 | 1.8 | 2.6 | 3.4 | 42 | 1824 |
| Co. Ex. 12 | 230 | 2.0 | 2.3 | 12.8 | 42 | 1161 |
| Co. Ex. 13 | 249 | 2.6 | 3.4 | 3.5 | 31 | 1534 |
| Co. Ex. 14 | 227 | 2.0 | 3.1 | 3.8 | 41 | 686 |
| Co. Ex. 15 | 210 | 2.5 | 0.8 | 11.2 | 61 | 1119 |
| Co. Ex. 16 | 202 | 2.3 | 0.6 | 3.6 | 43 | 1633 |

<Evaluation of Substrate Cross-Section after Pore Formation>

### (Fabrication of Anode Support for Solid Oxide Fuel Cell)

NiO (product name: NiO-FP, manufactured by Sumitomo Metal Mining Co., Ltd.) and YSZ (product name: TZ8YS, manufactured by Tosoh Corporation) were wet-mixed at a volume ratio of 40:60 and dried. 70 parts by mass of the obtained mixed powder and 10 parts by mass of the resin particles obtained in Example 1 or Comparative Example 11, 3 parts by mass of polyvinyl butyral as a binder, 3 parts by mass of dibutyl terephthalate as a plasticizer, 9 parts by mass of 2-propanol as a solvent, and 5 parts by mass of toluene were sufficiently kneaded with a bead mill to obtain a slurry for an anode support for a solid oxide fuel cell. The slurry was applied to a PET film by a doctor blade method and dried overnight at 90° C. to prepare a green sheet for support. The green sheet was heated at 1100° C. for 4 hours to prepare an anode support for a solid oxide fuel cell in which pores were formed.

(Fabrication of Polyimide Resin in which Pores are Formed)

After 11 parts by mass of 4,4-diaminodiphenyl ether (DDE, manufactured by Wakayama Seika Kogyo Co., Ltd.), 165 parts by mass of N,N-dimethylacetamide, and 2 parts by mass of the resin particles obtained in Example 1 or Comparative Example 11 were added to a dispersion vessel in a nitrogen atmosphere, the mixture was sufficiently stirred with a bead mill to obtain a DDE solution in which the resin particles were dispersed. The solution was then transferred to a three-neck flask and cooled in a dry ice-acetone bath to solidify the solution. To the three-neck flask containing the solution thus solidified was added 12 parts by mass of pyromellitic anhydride (manufactured by Tokyo Chemical Industry Co., Ltd.) under a nitrogen atmosphere and stirred at 25° C. for 12 hours to obtain a reaction solution. The obtained reaction solution was casted on a glass plate so that the thickness of the coating film after heat curing was 100 μm, thereby forming a coating film on the glass plate. Thereafter, the glass plate on which the coating film was formed was placed in a vacuum oven, heated under a pressure of 100 mmHg at a temperature of 40° C. for 12 hours, and then further heated under a pressure of 1 mmHg at a temperature of 400° C. for 1 hour to cure the coating film, thereby forming a film made of polyimide on the glass plate. Then, the glass plate on which the film made of polyimide was formed was taken out of the vacuum oven, immersed in water at 25° C. for 12 hours, and the film made of polyimide was collected from the glass plate to obtain a polyimide resin in which pores were formed.

The obtained anode support for a solid oxide fuel cell and the polyimide resin were cut by a focused ion beam processing apparatus (manufactured by Hitachi High-Tech Co., Ltd., FB-2100), and the cross section was observed by a scanning electron microscope. The pores obtained by using the resin particles obtained in Example 1 were spherical, no residue was found inside the pores, and no cracks were found in the substrate. On the other hand, a plurality of the pores formed by the resin particles of Comparative Example 11 were confirmed to have irregular shapes as like the spheres were crushed, residues were found inside the pores, and a plurality of cracks were found in the substrate.

1. Cross-linked methacrylate resin particles obtained by polymerizing monofunctional methacrylate and polyfunctional methacrylate, wherein
the blending amount of the monofunctional methacrylate is 60% by mass or more and 95% by mass or less and the blending amount of the polyfunctional methacrylate is 5% by mass or more and 40% by mass or less with respect to the total amount of methacrylate compound which is a raw material for the polymerization reaction;
the number of carbon atoms in the ester substituent of the monofunctional methacrylate is 3 or less; and
5% mass reduction temperature of the cross-linked methacrylate resin particles as measured by thermogravimetric differential thermal analysis is 180° C. or more and 240° C. or less.

2. The cross-linked methacrylate resin particles according to claim 1, wherein the monofunctional methacrylate is at least one selected from the group consisting of methyl methacrylate, ethyl methacrylate, n-propyl methacrylate, isopropyl methacrylate, hydroxyethyl methacrylate, hydroxypropyl methacrylate, and glycidyl methacrylate.

3. The cross-linked methacrylate resin particles according to claim 1, wherein the polyfunctional methacrylate is at least one selected from the group consisting of ethylene glycol dimethacrylate, diethylene glycol dimethacrylate, triethylene glycol dimethacrylate, tripropylene glycol dimethacrylate, polypropylene glycol dimethacrylate, polyethylene glycol dimethacrylate, and glycerin dimethacrylate.

4. The cross-linked methacrylate resin particles according to claim 1, wherein the compressive elastic modulus at 10% compression deformation is 2000 N/mm² or more and 3000 N/mm² or less.

5. The cross-linked methacrylate resin particles according to claim 1, wherein when the temperature is increased from 40° C. to 450° C. as measured by thermogravimetric differential thermal analysis, the amount of residue at the end of temperature increase is 2.0% by mass or less.

6. The cross-linked methacrylate resin particles according to claim 1, wherein the decomposition rate from 5% mass reduction temperature to 50% mass reduction temperature is 2.0% by mass/° C. or less as measured by thermogravimetric differential thermal analysis.

7. The cross-linked methacrylate resin particles according to claim 1, wherein the average particle diameter of the cross-linked methacrylate resin particles is preferably 0.5 μm or more and 20 μm or less.

8. The cross-linked methacrylate resin particles according to claim 1, wherein the coefficient of variation of the particle size of the cross-linked methacrylate resin particles is 10% or more and 50% or less.

9. A pore-forming agent comprising the cross-linked methacrylate resin particles according to claim 1.

10. A method comprising forming a solid oxide fuel cell with the pore-forming agent according to claim 9.

11. A method comprising forming an insulating wire with the pore-forming agent according to claim 9.

12. The cross-linked methacrylate resin particles according to claim 2, wherein the polyfunctional methacrylate is at least one selected from the group consisting of ethylene glycol dimethacrylate, diethylene glycol dimethacrylate, triethylene glycol dimethacrylate, tripropylene glycol dimethacrylate, polypropylene glycol dimethacrylate, polyethylene glycol dimethacrylate, and glycerin dimethacrylate.

13. The cross-linked methacrylate resin particles according to claim 12, wherein the compressive elastic modulus at 10% compression deformation is 2000 N/mm² or more and 3000 N/mm² or less.

14. The cross-linked methacrylate resin particles according to claim 13, wherein when the temperature is increased from 40° C. to 450° C. as measured by thermogravimetric differential thermal analysis, the amount of residue at the end of temperature increase is 2.0% by mass or less.

15. The cross-linked methacrylate resin particles according to claim 14, wherein the decomposition rate from 5% mass reduction temperature to 50% mass reduction temperature is 2.0% by mass/° C. or less as measured by thermogravimetric differential thermal analysis.

16. The cross-linked methacrylate resin particles according to claim 15, wherein the average particle diameter of the cross-linked methacrylate resin particles is preferably 0.5 μm or more and 20 μm or less.

17. The cross-linked methacrylate resin particles according to claim 16, wherein the coefficient of variation of the particle size of the cross-linked methacrylate resin particles is 10% or more and 50% or less.

18. A pore-forming agent comprising the cross-linked methacrylate resin particles according to claim 17.

19. A method comprising forming a solid oxide fuel cell with the pore-forming agent according to claim 18.

20. A method comprising forming an insulating wire with the pore-forming agent according to claim 18.
